(19) United States
(12) Patent Application Publication
(10) Pub. No.: US 2026/0094026 A1
(43) Pub. Date: Apr. 2, 2026

(54) ELECTRONIC DEVICE, METHOD, AND NON-TRANSITORY COMPUTER READABLE STORAGE MEDIUM FOR OBTAINING INSTANCE

(71) Applicant: Samsung Electronics Co., Ltd., Suwon-si (KR)

(72) Inventors: Jungbae KIM, Suwon-si (KR); Dohyoung KIM, Suwon-si (KR); Mooyoung KIM, Suwon-si (KR); Euntaik LEE, Suwon-si (KR); Seungjin KIM, Suwon-si (KR); Hyeonsu LEE, Suwon-si (KR); Gyusung CHO, Suwon-si (KR)

(21) Appl. No.: 19/250,699

(22) Filed: Jun. 26, 2025

Related U.S. Application Data
(63) Continuation of application No. PCT/KR2025/008207, filed on Jun. 13, 2025.

(30) Foreign Application Priority Data
Sep. 27, 2024 (KR) 10-2024-0132205
Dec. 23, 2024 (KR) 10-2024-0194729
Jan. 7, 2025 (KR) 10-2025-0002481

(51) Int. Cl. G06N 5/04

(52) U.S. Cl. CPC G06N 5/04

(57) ABSTRACT

An electronic device is provided. The electronic device includes non-volatile memory including one or more storage media storing instructions, volatile memory including one or more storage media, and at least one processor including processing circuitry, the at least one processor communicatively coupled to the non-volatile memory and the volatile memory, wherein the instructions, when executed by the at least one processor individually or collectively, cause the electronic device to receive input data for using a function of a pre-trained model stored in the non-volatile memory, based on loading first composition information of the pre-trained model into the volatile memory, obtain an instance in accordance with the loaded first composition information, and load second composition information of the pre-trained model, which is distinguished from the first composition information of the pre-trained model, into the volatile memory, independently of performing inference for the input data by executing the obtained instance.

### CROSS-REFERENCE TO RELATED APPLICATION(S)

This application is a continuation application, claiming priority under 35 U.S. C. § 365(c), of an International application No. PCT/KR2025/008207, filed on Jun. 13, 2025, which is based on and claims the benefit of a Korean patent application number 10-2024-0132205, filed on Sep. 27, 2024, in the Korean Intellectual Property Office, of a Korean patent application number 10-2024-0194729, filed on Dec. 23, 2024, in the Korean Intellectual property office, and of a Korean patent application number 10-2025-0002481, filed on Jan. 7, 2025, in the Korean Intellectual Property Office, the disclosure of each of which is incorporated by reference herein in its entirety.

### TECHNICAL FIELD

The disclosure relates to an electronic device, a method, and a non-transitory computer-readable storage medium for obtaining an instance.

### BACKGROUND ART

With the development of an electronic device, the development of technology related to an electronic device equipped with artificial intelligence (AI) technology is in progress. The electronic device equipped with artificial intelligence technology may provide various services to a user. For example, the electronic device equipped with artificial intelligence technology may provide a response to an input prompt by performing natural language processing on the input prompt.

The above information is presented as background information only to assist with an understanding of the disclosure. No determination has been made, and no assertion is made, as to whether any of the above might be applicable as prior art with regard to the disclosure.

### DISCLOSURE

### Technical Solution

Aspects of the disclosure are to address at least the above-mentioned problems and/or disadvantages and to provide at least the advantages described below. Accordingly, an aspect of the disclosure is to provide a method and an electronic device for a non-transitory computer-readable storage medium for obtaining an instance.

Additional aspects will be set forth in part in the description which follows and, in part, will be apparent from the description, or may be learned by practice of the presented embodiments.

In accordance with an aspect of the disclosure, an electronic device is provided. The electronic device includes non-volatile memory including one or more storage media storing instructions, volatile memory comprising one or more storage media, and at least one processor comprising processing circuitry, the at least one processor communicatively coupled to the non-volatile memory and the volatile memory, wherein the instructions, when executed by the at least one processor individually or collectively, cause the electronic device to receive input data for using a function of a pre-trained model stored in the non-volatile memory. The instructions, when executed by the at least one processor individually or collectively, may cause the electronic device to obtain, based on loading first composition information of the pre-trained model into the volatile memory, an instance in accordance with the loaded first composition information. The instructions, when executed by the at least one processor individually or collectively, may cause the electronic device to load second composition information of the pre-trained model, which is distinguished from the first composition information of the pre-trained model, into the volatile memory, independently of performing inference for the input data by executing the obtained instance.

In accordance with another aspect of the disclosure, A method performed by an electronic device with non-volatile memory and volatile memory is provided. The method includes receiving, by the electronic device, input data for using a function of a pre-trained model stored in the non-volatile memory. The method may includes obtaining, by the electronic device, based on loading first composition information of the pre-trained model into the volatile memory, an instance in accordance with the loaded first composition information. The method may includes loading, by the electronic device, second composition information of the pre-trained model, which is distinguished from the first composition information of the pre-trained model, into the volatile memory, independently of performing inference for the input data by executing the obtained instance.

In accordance with another aspect of the disclosure, one or more non-transitory computer-readable storage media storing one or more computer programs including computer-executable instructions that, when executed by at least one processor of an electronic device including non-volatile memory and volatile memory individually or collectively, cause the electronic device to perform operations are provided. The operations may include receiving, by the electronic device, input data for using a function of a pre-trained model stored in the non-volatile memory, based on loading first composition information of the pre-trained model into the volatile memory. The operations may include obtaining, by the electronic device, an instance in accordance with the loaded first composition information. The operations may include loading, by the electronic device, second composition information of the pre-trained model, which is distinguished from the first composition information of the pre-trained model, into the volatile memory, independently of performing inference for the input data by executing the obtained instance.

Other aspects, advantages, and salient features of the disclosure will become apparent to those skilled in the art from the following detailed description, which, taken in conjunction with the annexed drawings, discloses various embodiments of the disclosure.

### DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram of an electronic device in a network environment according to an embodiment of the disclosure;

FIG. 2 is a diagram for describing a neural network executed in an electronic device according to an embodiment of the disclosure;

FIG. 3 illustrates an example of a simplified block diagram of an electronic device according to an embodiment of the disclosure;

FIG. 4 illustrates an example of loading composition information of a model stored in non-volatile memory into volatile memory according to an embodiment of the disclosure;

FIG. 5 illustrates an example of operations of an electronic device that obtains an instance in accordance with a model stored in non-volatile memory according to an embodiment of the disclosure;

FIG. 6 illustrates an example of operations of an electronic device that obtains an instance according to an embodiment of the disclosure;

FIG. 7 illustrates an example of a second instance to verify inference data of a first instance according to an embodiment of the disclosure; and

FIG. 8 illustrates an example of operations of an electronic device that executes one or more instances according to an embodiment of the disclosure.

Throughout the drawings, it should be noted that like reference numbers are used to depict the same or similar elements, features, and structures.

### MODE FOR INVENTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and word used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface”includes reference to one or more of such surfaces.

In various embodiments of the disclosure described below, a hardware approach will be described as an example. However, since the various embodiments of the disclosure include technology that uses both hardware and software, the various embodiments of the disclosure do not exclude a software-based approach.

In the following description, a term (e.g., weight data, graph data, input data, output data, inference data, token, and composition information) referring to data, a term referring to a value, a term (e.g., an operation, a process) referring to a computational state, a term referring to an object, a term referring to network entities, a term referring to a component of a device, and the like are exemplified for convenience of explanation. Therefore, the disclosure is not limited to the terms described below, and another term with an equivalent technical meaning may be used.

In addition, in the disclosure, the term ‘greater than’ or ‘less than’ may be used to determine whether a particular condition is satisfied or fulfilled, but this is only a description to express an example and does not exclude description of ‘greater than or equal to’ or ‘less than or equal to’. A condition described as ‘greater than or equal to’ may be replaced with ‘greater than’, a condition described as ‘less than or equal to’ may be replaced with ‘less than’, and a condition described as ‘greater than or equal to and less than’ may be replaced with ‘greater than and less than or equal to’. In addition, hereinafter, ‘A’ to ‘B’ refers to at least one of elements from A (including A) to B (including B). Hereinafter, ‘C’ and/or ‘D’ means including at least one of ‘C’ or ‘D’, that is, {‘C’, ‘D’, and ‘C’ and ‘D’}.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

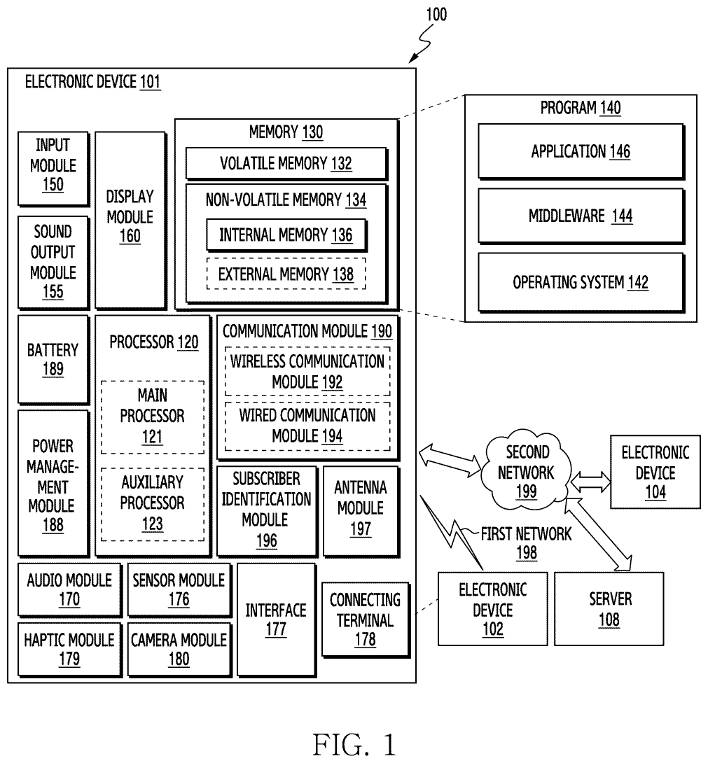

FIG. 1 is a block diagram of an electronic device in a network environment according to an embodiment of the disclosure.

Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, an HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5th generation (5G) network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4th generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the millimeter wave (mmWave) band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, an RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102 or 104, or the server 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

In the disclosure, a technology related to artificial intelligence (or an artificial intelligence model) may be described. A function related to artificial intelligence is operated through a processor (e.g., the processor 120) and memory (e.g., the memory 130). The processor may be composed of one or more processors. In this case, the one or more processors may be general-purpose processors, such as a central processing unit (CPU), an application processor (AP), a digital signal processor (DSP), and the like, graphic-specific processors, such as a graphic processing unit (GPU), or a vision processing unit (VPU), or artificial intelligence-specific processors, such as a neural processing unit (NPU). The one or more processors process input data in accordance with a predefined operating rule or an artificial intelligence model stored in the memory. Alternatively, in a case that the one or more processors are artificial intelligence-specific processors, the artificial intelligence-specific processor may be designed with a hardware structure specialized for processing a specific artificial intelligence model.

The predefined operating rule or artificial intelligence model is characterized as being generated through learning. Herein, ‘being generated through learning’ means that a base artificial intelligence model is trained using a plurality of learning data by a learning algorithm, thereby generating the predefined operating rule or artificial intelligence model that is set to perform a desired characteristic (or an objective). Such learning may take place in a device (e.g., the electronic device 101) itself, on which the artificial intelligence in accordance with the disclosure is performed, or it may take place through a separate server and/or system. An example of the learning algorithm includes supervised learning, unsupervised learning, semi-supervised learning, or reinforcement learning, but is not limited to the above-described example.

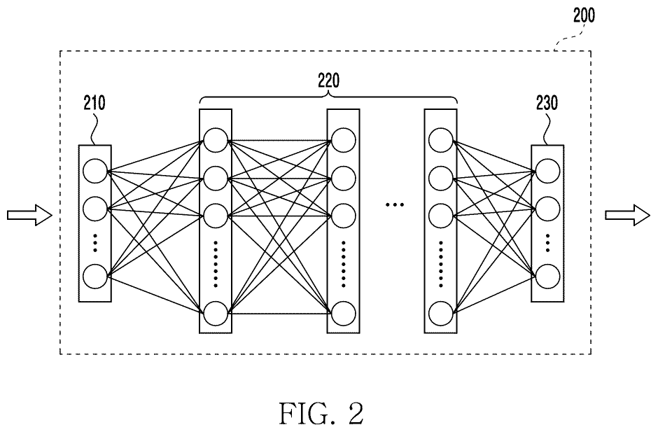

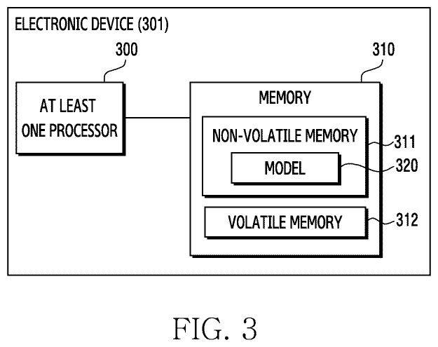

An artificial intelligence model (e.g., a model 320 of FIG. 3) may be composed of a plurality of neural network layers (e.g., a neural network 200 of FIG. 2). Each of the plurality of neural network layers has a plurality of weight values and performs a neural network computation through a computation between a computation result of a previous layer and the plurality of weight values. The plurality of weight values of the plurality of neural network layers may be optimized by a learning result of the artificial intelligence model. For example, the plurality of weight values may be updated such that a loss value or a cost value obtained from the artificial intelligence model is reduced or minimized during a learning process. An artificial neural network may include a deep neural network (DNN), and, for example, a convolutional neural network (CNN), the deep neural network (DNN), a recurrent neural network (RNN), a restricted Boltzmann machine (RBM), a deep belief network (DBN), a bidirectional recurrent deep neural network (BRDNN), Deep Q-networks, and the like, but is not limited to the examples described above.

An electronic device (e.g., the electronic device 101) according to the disclosure may use the artificial intelligence model to recommend, execute, and/or infer a response to input data (e.g., a prompt). The processor (e.g., the processor 120) may perform a preprocessing process on the input data and convert it into a form suitable for use as an input of the artificial intelligence model. The artificial intelligence model may be generated through learning. Herein, being generated through learning means that a base artificial intelligence model is trained using a plurality of learning data by a learning algorithm, thereby generating a predefined operating rule or an artificial intelligence model that is set to perform a desired characteristic (or an objective). The artificial intelligence model may be composed of a plurality of neural network layers. Each of the plurality of neural network layers has a plurality of weight values and performs a neural network computation through a computation between a computation result of a previous layer and the plurality of weight values. Inference prediction is a technology that logically infers and predicts by judging information, and includes knowledge-based reasoning, probabilistic reasoning, optimization prediction, preference-based planning, recommendation, and the like.

FIG. 2 is a diagram for describing a neural network 200 executed in an electronic device (e.g., the electronic device 101 of FIG. 1) according to an embodiment of the disclosure. According to an embodiment, the neural network 200 of FIG. 2 may be obtained from a set of parameters stored in memory (e.g., the memory 130 of FIG. 1) by the electronic device 101. For example, the neural network 200 may be an example of a model stored in the memory 130. For example, the set of parameters may be included in composition information of the model stored in the memory 130.

Referring to FIG. 2, the neural network 200 may include a plurality of layers. For example, the neural network 200 may include an input layer 210, one or more hidden layers 220, and an output layer 230. The input layer 210 may correspond to a vector and/or a matrix indicating input data of the neural network 200. For example, the vector indicating the input data may have elements corresponding to the number of nodes included in the input layer 210. For example, elements included in the matrix indicating the input data may correspond to each of the nodes included in the input layer 210. Based on the input data, signals generated at each of the nodes in the input layer 210 may be transmitted from the input layer 210 to the hidden layers 220. The output layer 230 may generate output data of the neural network 200 based on one or more signals received from the hidden layers 220. For example, the output data may correspond to a vector and/or a matrix with elements corresponding to the number of nodes included in the output layer 230.

According to an embodiment, first nodes included in a specific layer among the plurality of layers included in the neural network 200 may correspond to a weighted sum of at least one of second nodes of a previous layer of the specific layer in a sequence of the plurality of layers. According to an embodiment, the electronic device 101 may identify a weight value to be applied to the at least one of the second nodes from the set of parameters stored in the memory 130. Training the neural network 200 may include an operation of changing and/or determining one or more weight values related to the weighted sum.

Referring to FIG. 2, the one or more hidden layers 220 may be positioned between the input layer 210 and the output layer 230, and may convert input data transmitted through the input layer 210 into a value that is easy to predict. The input layer 210, the one or more hidden layers 220, and the output layer 230 may include a plurality of nodes. The one or more hidden layers 220 may be convolution filters or fully connected layers in a convolutional neural network (CNN), or various types of filters or layers grouped based on a special function or characteristic. In an embodiment, the one or more hidden layers 220 may be layers based on a recurrent neural network (RNN), in which an output value is fed back into a hidden layer at the current time. According to an embodiment, the neural network 200 may include numerous hidden layers 220 and form a deep neural network. Training a deep neural network is referred to as deep learning. Among nodes of the neural network 200, a node included in the hidden layers 220 is referred to as a hidden node.

According to an embodiment, the nodes included in the input layer 210 and the one or more hidden layers 220 may be connected to each other through a connection line with a connection weight value, and the nodes included in a hidden layer and the output layer 230 may also be connected to each other through a connection line with a connection weight value. Tuning and/or training the neural network 200 may mean changing the connection weight value between the nodes included in each of the layers (e.g., the input layer 210, the one or more hidden layers 220, and the output layer 230) included in the neural network 200. For example, the tuning of the neural network 200 may be performed based on supervised learning and/or unsupervised learning.

According to an embodiment, in a state of obtaining the neural network 200, the electronic device 101 may identify a weight value corresponding to a connection line connecting the input layer 210, the one or more hidden layers 220, and/or the output layer 230 stored in the memory (e.g., the memory 130). The electronic device 101 may sequentially obtain a weighted sum based on a connection line along the plurality of layers (e.g., the input layer 210, the one or more hidden layers 220, and the output layer 230) of the neural network 200 in order to obtain output data from the neural network 200 based on the identified weight value. The obtained weighted sum may be stored in at least one processor (e.g., the processor 120) and/or the memory 130 of the electronic device 101. For example, the electronic device 101 may repeatedly update the weighted sum stored in the memory 130 by sequentially obtaining the weighted sum along the plurality of layers.

Each of the plurality of layers of the neural network 200 may have an independent data type and/or precision. For example, in a case that connection lines between a first layer and a second layer among the plurality of layers have weight values based on a first data type for representing a floating point number, the electronic device 101 may obtain weighted sums based on the first data type, from numerical values and weight values corresponding to nodes of the first layer. In the above example, in a case that connection lines between the second layer and a third layer among the plurality of layers have weight values based on a second data type for representing an integer number, the electronic device 101 may obtain weighted sums based on the second data type, from the obtained weighted sums and weight values based on the second data type.

According to an embodiment, when the plurality of layers have different data types, the electronic device 101 may obtain weighted sums corresponding to each of the plurality of layers based on the different data types using the at least one processor (e.g., the processor 120). As the electronic device 101 accesses the memory 130 based on the weighted sums obtained based on the different data types, bandwidth of the memory 130 may be used more efficiently. For example, as the bandwidth of the memory 130 is used more efficiently, the electronic device 101 may obtain output data more quickly from the neural network 200 based on the plurality of layers.

According to an embodiment, the electronic device 101 may store sets of parameters indicating each of a plurality of neural networks with different precisions. For example, a neural network related to super resolution for upscaling an image and/or video may require the precision of a data type for representing a floating point number based on 32 bits. For example, the neural network related to the super resolution for upscaling an image and/or video may require the precision of a data type (e.g., a half-precision floating point format defined by IEEE 754) for representing a floating point number based on 16 bits. For example, a neural network for recognizing a subject included in an image and/or video may require the precision of a data type for representing an integer number based on 8 bits and/or 4 bits. For example, a neural network for performing handwriting recognition may require the precision of a data type for representing an integer number based on a first bit and/or second bits. For example, the electronic device 101 may perform a computation for obtaining a weighted sum based on different precisions corresponding to each of the plurality of neural networks.

A model (e.g., a model 320 of FIG. 3) described in the disclosure may include a large language model (LLM) (or a large multimodal model (LMM)). However, it is not limited thereto. For example, although a description of the LLM (or the LMM) is described below, it is obvious that an artificial intelligence neural network of the disclosure may include various foundation models such as a code model, an image model, and other artificial intelligence neural network models in addition to a language model.

An artificial intelligence model (e.g., the model 320 of FIG. 3) according to an embodiment of the disclosure may mean the LLM, which is an artificial neural network-based language model that has learned a large amount of text data through pre-training. The LLM may include relatively more parameters (e.g., greater than or equal to 10 billion) than an existing general language model. The LLM may use a transformer artificial neural network structure based on an attention mechanism.

The attention mechanism is a technique that helps an artificial intelligence model to apply its attention to important parts in the input data. The attention mechanism may be utilized to predict the output data by predicting a degree to which a portion of temporal input data (e.g., input data such as voice or video, or input data of a portion of layers of the neural network) contributes to an intermediate or final output of the neural network. The recurrent neural network (RNN) structure that sequentially processes each element of the sequence has poor prediction performance in a case in which there is information dependency between long temporal distances, but the attention mechanism may consider the information dependency between the long temporal distances by controlling a degree of a weight value attention in the overall context (or a portion thereof) of the input data.

A transformer may be composed of an encoder-decoder structure. The encoder may process input data and output compression information (e.g., contextual representation), and the decoder may process the compression information and output output data in token units. Each of the encoder and the decoder may include an independent attention network, and may include a cross-attention network connecting the encoder and the decoder.

According to an embodiment, LLM learning may include pre-training and/or fine-tuning. The pre-training is a process of enabling the LLM to obtain general language knowledge by using a large amount of text data, and may include, for example, self-supervised learning, in which the model predicts the next word using a previous word sequence in a text string. The fine tuning is a process of training the LLM to be suitable for a specific domain (e.g., chatbot, translation, summarization, and question & answer (Q&A)) or task, and the LLM may be additionally trained through supervised learning (or adaptive learning) using a dataset suitable for the domain objective, based on the pre-trained model. The LLM may perform a task using a text input, which is called a prompt, that includes a natural language.

For example, the fine tuning may be omitted during the LLM learning. A user may control a prompt to be inputted to the LLM to improve a performance of a desired task. In the same way as in-context learning or zero-shot/few-shot learning, an example of the task and guidance for performing the task may be additionally provided to the prompt. There are bidirectional encoder representations from transformer (BERT), a generative pre-trained transformer (GPT), and the like, as published LLMs.

The term ‘LLM’ may refer to a language neural network model itself, but may also mean a model for an LLM-based application (e.g., chatbot, translation, summarization, text classification, and sentence generation). For example, an LLM-based chatbot such as ChatGPT or an LLM-based translator may also be referenced as ‘LLM’. The ‘LLM’ may include an inference engine using an LLM neural network model. For example, “input an input prompt to the LLM” may mean “input the input prompt to an LLM-based inference engine.” For example, ‘output of the LLM for the input prompt’ may mean output information (or output information modified through additional processing) of a last neural network layer of the LLM that is obtained when the input prompt is inputted to the LLM-based inference engine.

FIG. 3 illustrates an example of a simplified block diagram of an electronic device 301 according to an embodiment of the disclosure. The electronic device 301 may be an example of the electronic device 101 of FIG. 1.

Referring to FIG. 3, the electronic device 301 may include at least one processor 300 and/or memory 310. For example, the at least one processor 300 and/or the memory 310 may be electronically and/or operably coupled with each other by a communication bus. Hereinafter, hardware components operably coupled may mean that a direct connection or an indirect connection between the hardware components is established, either wired or wireless, such that a second hardware component is controlled by a first hardware component among the hardware components. Hardware components illustrated in FIG. 3 are illustrated based on different blocks, but the disclosure is not limited thereto.

The at least one processor 300 may include a hardware component for processing data based on executing instructions. The at least one processor 300 may be configured to execute instructions stored in the memory 310 individually or collectively. The at least one processor 300 may include processing circuitry. For example, the hardware component for processing data may include an arithmetic and logic unit (ALU), a floating point unit (FPU), and a field programmable gate array (FPGA). For example, the hardware component for processing data may include a central processing unit (CPU), a graphic processing unit (GPU), a display processing unit (DPU), a neural processing unit (NPU), a digital signal processor (DSP), an application processor (AP), and/or a microcontroller (MCU). For example, the NPU may include a hardware component dedicated to computations related to a model 320. For example, the NPU may include a plurality of circuits for performing computations (e.g., multiplication and/or addition) performed continuously and/or in parallel based on the model 320. The plurality of circuits included in the NPU may be referenced as neural engines. The NPU may perform the computations based on a designated data type (e.g., a floating point number and/or an integer number) related to the model 320. For example, the GPU may include one or more pipelines that perform a plurality of operations for executing instructions related to computer graphics and/or a parallel computation. For example, a pipeline of the GPU may include a graphics pipeline or a rendering pipeline for generating a three-dimensional image and generating a two-dimensional raster image from the generated 3D image. Using graphics pipelines, computations related to an artificial neural network (e.g., the neural network 200) may be executed substantially simultaneously.

According to an embodiment, the at least one processor 300 may include one or more cores. For example, the at least one processor 300 may have a structure of a multi-core processor such as a dual core, a quad core, or a hexa core.

According to an embodiment, hereinafter, in terms of an entity performing the computations of the artificial neural network indicated by the model 320, the at least one processor 300 may be referenced as an artificial intelligence (AI) accelerator. The AI accelerator may be referred to as an accelerator.

The memory 310 may include one or more storage media. The memory 310 may include non-volatile memory 311 and/or volatile memory 312. The non-volatile memory 311 may include a hardware component for storing data and/or instructions that are inputted to and/or outputted from the at least one processor 300. The non-volatile memory 311 may include, for example, at least one of read-only memory (ROM), a programmable ROM (PROM), erasable PROM (EPROM), an electrically erasable PROM (EEPROM), flash memory, a hard disk, a compact disk, or an embedded multimedia card (EMMC). For example, in the non-volatile memory 311 of the electronic device 301, one or more instructions (or commands) indicating a computation and/or an operation to be performed on data by the at least one processor 300 of the electronic device 301 may be stored. A set of the one or more instructions may be referenced as a program, firmware, an operating system, a process, a routine, a sub-routine and/or an application. The volatile memory 312 may include at least one of random-access memory (RAM), a dynamic RAM (DRAM), a static RAM (SRAM), a cache RAM, or a pseudo SRAM (PSRAM). For example, the memory 310 may correspond to the memory 130 of FIG. 1. For example, the non-volatile memory 311 may correspond to the non-volatile memory 134 of FIG. 1. For example, the volatile memory 312 may correspond to the volatile memory 132 of FIG. 1.

According to an embodiment, the non-volatile memory 311 may include the model 320. The model 320 may be stored in the non-volatile memory 311. The model 320 may include the neural network 200 of FIG. 2. For example, the model 320 stored in the non-volatile memory 311 may be indicated by a file stored in the non-volatile memory 311. For example, the electronic device 301 may execute functions similar to human cognitive action or learning process based on the model 320. Based on computations indicated by the model 320 and performed in a chain by a plurality of parameters, the electronic device 301 may output data including generalized information on input data (e.g., a prompt). The non-volatile memory 311 of the electronic device 301 may store composition information of the model 320. For example, the composition information may include graph data related to the model 320 and/or weight data related to the model 320. For example, a structure and a computation of the model 320 may be described by the graph data. For example, the graph data may indicate a computation, a variable, and/or a connection relationship of the model 320. According to an embodiment, the electronic device 301 may perform the computations indicated by the model 320 based on the weight data of the model 320. For example, the weight data may include a plurality of nodes indicated by the model 320 and/or weight values assigned to a connection between the plurality of nodes. As a non-limiting example, the composition information may include a hyperparameter related to the model 320. For example, the hyperparameter may include at least one of a learning rate, a cost function, a regularization parameter, a mini-batch size, the number of training iterations, the number of hidden layers, a meta parameter, or a free parameter.

The electronic device 301 may load the model 320 stored in the non-volatile memory 311 into the volatile memory 312. For example, the electronic device 301 may load (or copy) the composition information of the model 320 stored in the non-volatile memory 311 into the volatile memory 312. The electronic device 301 may obtain an instance (e.g., a plurality of instructions) for performing the computations indicated by the model 320 based on the composition information loaded into the volatile memory 312. The at least one processor 300 (e.g., the accelerator) may execute one or more functions related to the model 320 stored in the volatile memory 312 based on the instance. The one or more functions may include at least one of a function of performing inference for the input data based on the model 320, a function of performing image-based object recognition, voice recognition, and/or handwriting recognition using a pre-trained model (e.g., the model 320), and a function personalized to a user of the electronic device 301 based on the neural network. However, the embodiment is not limited thereto.

According to an embodiment, the electronic device 301 may perform computations related to the input data based on the model 320 using the accelerator. The electronic device 301 may obtain output data (e.g., inference data) from the input data, which is inputted as an instance in accordance with the model 320, based on performing the chained (or serial or consecutive) computations based on the plurality of parameters of the model 320.

According to an embodiment, the model 320 (or the instance in accordance with the model 320) may include the plurality of nodes. The plurality of nodes may be divided by layer units. In an embodiment, in which the plurality of parameters include weight values connecting two nodes of different layers of the model 320 (or the instance in accordance with the model 320), the electronic device 301 may obtain values corresponding to nodes of another layer connected to a specific layer by applying weight values to values corresponding to nodes of the specific layer.

According to an embodiment, the model 320 stored in the non-volatile memory 311 may be a pre-trained model. For example, the pre-trained model may include an on-device model. For example, the pre-trained model may be a freeze model. The freeze model may be described as a model in which at least a portion of composition information is fixed. For example, the freeze model may be a model in which weight data is fixed. For example, the freeze model may be referenced as a model in which learning has been completed and that is capable of performing inference for input data. For example, the freeze model may be referred to as an offline compiled model.

According to an embodiment, the model 320 may support an early exit inference method and/or self-speculative decoding. For example, the early exit inference method may be referenced as a method of performing inference using only a portion of the computations based on the model 320. The early exit inference method may have a relatively high inference speed. For example, the self-speculative decoding may be referenced as a method for improving the accuracy of inference data by performing verification on inferred inference data (e.g., inference data obtained in accordance with the early exit inference method).

According to an embodiment, the model 320 may include a draft model and a full layer model. The draft model may be a simplified model designed to generate quick initial results. The electronic device 301 may perform inference faster than the full layer model using the draft model. The electronic device 301 may perform, using the full layer model, verification on inference data (e.g., token), which is a result of inference performed by the draft model. Although the accuracy of the inference data of the draft model may be relatively low, the accuracy of the inference data of the draft model may be guaranteed by verifying (or supplementing) the inference data of the draft model by the full layer model. The electronic device 301 may perform inference for the input data faster when using both the draft model and the full layer model than when using the full layer model alone. For example, time to first token (TTFT) when using both the draft model and the full layer model may be smaller than TTFT when using the full layer model alone. Layers in the draft model may correspond to at least a portion of layers in the full layer model. For example, the number of layers in the draft model may be less than the number of layers in the full layer model.

According to an embodiment, in a case of using the on-device model (e.g., the model 320), the electronic device 301 may store each of a plurality of draft models and the full layer model independently in the non-volatile memory 311. For example, as the number of draft models increases, the electronic device 301 may have a problem in which remaining capacity of the non-volatile memory 311 decreases. For example, as the number of draft models increases, the electronic device 301 may have a problem in which usage of the volatile memory 312 increases.

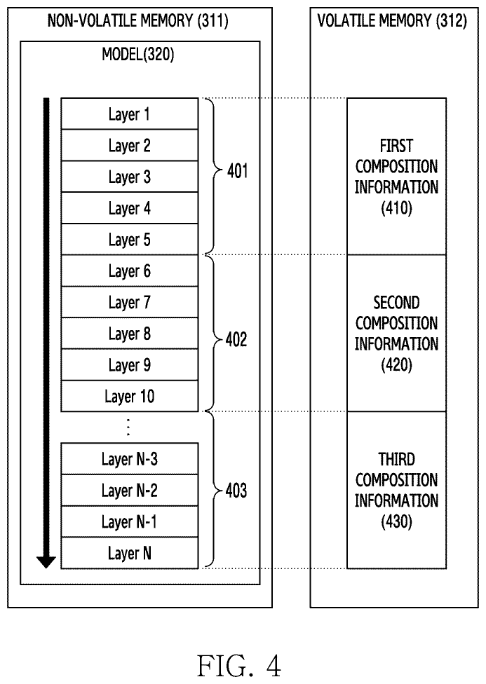

In the disclosure, a technique in which the electronic device 301 obtains one or more instances by reading the one model 320 stored in the non-volatile memory 311 may be described. In addition, since the electronic device 301 loads the composition information of the one model 320 into the volatile memory 312, the usage of the volatile memory 312 may be reduced. This method will be described and illustrated with reference to FIGS. 4, 5, 6, 7, and/or 8.

FIG. 4 illustrates an example of loading composition information of a model 320 stored in non-volatile memory 311 into volatile memory 312 according to an embodiment of the disclosure.

Referring to FIG. 4, the model 320 may be stored in the non-volatile memory 311. For example, the model 320 may be indicated by a file stored in the non-volatile memory 311. For example, the model 320 may be an on-device model. For example, the model 320 may be a freeze model. For the freeze model, descriptions of the freeze model of FIG. 3 may be referenced. For example, the model 320 may be in a pre-compiled state. For example, the model 320 may be a pre-trained model. The model 320 may be composed of a plurality of layers. For example, the model 320 may include first layers 401, second layers 402, and/or third layers 403.

According to an embodiment, an electronic device (e.g., the electronic device 301) may obtain or generate an instance to execute a function of the model 320. The electronic device 301 may load (or copy) the model 320 into the volatile memory 312 to obtain the instance. For example, the electronic device 301 may load composition information of the model 320 into the volatile memory 312. For example, the electronic device 301 may load the composition information of the model 320 into the volatile memory 312 by sequentially reading the layers of the model 320. For example, the electronic device 301 may load first composition information 410 into the volatile memory 312 by reading the first layers 401. The first composition information 410 may correspond to the first layers 401. For example, the first composition information 410 may include weight data of nodes in the first layers 401 and/or graph data of the first layers 401. As a non-limiting example, the first composition information 410 may include early exit information. For example, the electronic device 301 may obtain or generate a first instance in accordance with the first composition information based on identifying the early exit information.

According to an embodiment, the electronic device 301 may read the second layers 402 after reading the first layers 401. For example, the electronic device 301 may load second composition information 420 into the volatile memory 312 by reading the first layers 401. The second composition information 420 may correspond to the second layers 402. For example, the second composition information 420 may include weight data of nodes in the second layers 402 and/or graph data of the second layers 402. As a non-limiting example, the second composition information 420 may include the early exit information. For example, the electronic device 301 may obtain or generate a second instance in accordance with the first composition information 410 and the second composition information 420 based on identifying the early exit information.

According to an embodiment, the electronic device 301 may read the third layers 403 after reading the second layers 402. For example, the electronic device 301 may load third composition information 430 into the volatile memory 312 by reading the third layers 403 after reading the second layers 402. The third composition information 430 may correspond to the third layers 403. For example, the third composition information 430 may include weight data of nodes in the third layers 403 and/or graph data of the third layers 403. As a non-limiting example, the third composition information 430 may include the early exit information. For example, the electronic device 301 may obtain or generate a third instance in accordance with the first composition information 410, the second composition information 420, and the third composition information 430 based on identifying the early exit information.

According to an embodiment, a size (or a capacity) of the composition information (e.g., the first composition information 410, the second composition information 420, and the third composition information 430) loaded into the volatile memory 312 may correspond to a size (or a capacity) of the model 320. The first composition information 410 loaded into the volatile memory 312 may be used to obtain the first instance, may be used to obtain the second instance, and may be used to obtain the third instance. The second composition information 420 loaded into the volatile memory 312 may be used to obtain the second instance, and may be used to obtain the third instance. The electronic device 301 may efficiently utilize usage of the volatile memory 312 and a capacity of the non-volatile memory 311 by sharing the composition information (e.g., the first composition information 410 and the second composition information 420) loaded in the volatile memory 312 to obtain instances (e.g., the second instance and the third instance).

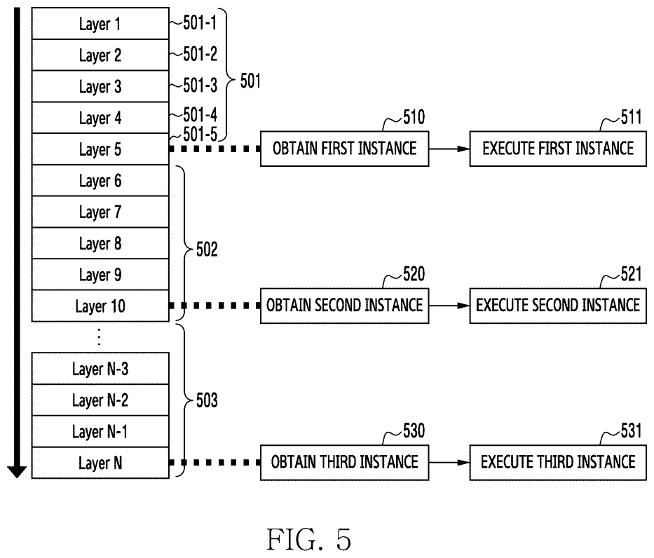

FIG. 5 illustrates an example of operations of an electronic device (e.g., the electronic device 301) that obtains an instance in accordance with a model (e.g., the model 320) stored in non-volatile memory (e.g., the non-volatile memory 311) according to an embodiment of the disclosure.

Referring to FIG. 5, the model 320 may be composed of a plurality of layers. For example, the model 320 may include first layers 501 (e.g., first layers 401), second layers 502 (e.g., second layers 402), and/or third layers 503 (e.g., third layers 403). The electronic device 301 may load the model 320 into volatile memory 312 by reading the plurality of layers. For example, the electronic device 301 may load composition information of the model 320 into the volatile memory 312. Descriptions of FIG. 4 may be referenced for the electronic device 301 to load the composition information of the model 320 into the volatile memory 312.

According to an embodiment, the electronic device 301 may load composition information of each of the first layers 501 into the volatile memory 312 by sequentially reading the first layers 501 (e.g., a layer 501-1, a layer 501-2, a layer 501-3, a layer 501-4, and a layer 501-5). For example, the electronic device 301 may load composition information corresponding to the layer 501-1 into the volatile memory 312 by reading the layer 501-1. For example, the electronic device 301 may load composition information corresponding to the layer 501-2 into the volatile memory 312 by reading the layer 501-2 after reading the layer 501-1. For example, the electronic device 301 may load composition information corresponding to the layer 501-3 into the volatile memory 312 by reading the layer 501-3 after reading the layer 501-2. For example, the electronic device 301 may load composition information corresponding to the layer 501-4 into the volatile memory 312 by reading the layer 501-4 after reading the layer 501-3. For example, the electronic device 301 may load composition information corresponding to the layer 501-5 into the volatile memory 312 by reading the layer 501-5 after reading the layer 501-4. According to an embodiment, the composition information corresponding to the layer 501-5 may include an end point. However, it is not limited thereto. The electronic device 301 may store end point information indicating at least one end point in the non-volatile memory 311. The electronic device 301 may execute an operation 510 in accordance with the end point.

According to an embodiment, in operation 510, the electronic device 301 may obtain or generate a first instance. The electronic device 301 may obtain or generate the first instance based on first composition information (e.g., the first composition information 410) corresponding to the first layers 501. The electronic device 301 may execute an operation 511 in response to obtaining the first instance.

In operation 511, the electronic device 301 may execute the first instance in response to obtaining the first instance. The electronic device 301 may execute a function corresponding to the first layers 501 by executing the first instance. The electronic device 301 may perform inference for input data by executing the first instance.

According to an embodiment, the electronic device 301 may read the second layers 502 independently of the operation 510 and/or the operation 511. Since execution of the operation 510 and/or the operation 511 of the electronic device 301 and the operation of the electronic device 301 reading the second layers 502 are independent, the execution of the operation 510 and/or the operation 511 of the electronic device 301 and the operation of the electronic device 301 reading the second layers 502 may be performed simultaneously. The electronic device 301 may load composition information of each of the second layers 502 into the volatile memory 312 by sequentially reading each of the second layers 502. For example, the electronic device 301 may identify an end point included in composition information of a last layer (e.g., a layer 10) in the second layers 502. For example, the electronic device 301 may execute an operation 520 in accordance with the end point.

According to an embodiment, in operation 520, the electronic device 301 may obtain or generate a second instance. The electronic device 301 may obtain or generate the second instance based on the first composition information (e.g., the first composition information 410) corresponding to the first layers 501 and second composition information (e.g., the second composition information 420) corresponding to the second layers 502. The electronic device 301 may execute an operation 521 in response to obtaining the second instance.

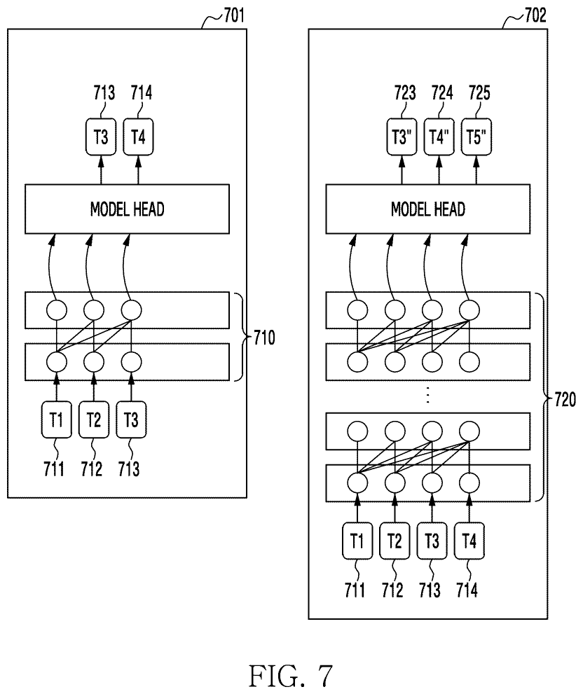

In operation 521, the electronic device 301 may execute the second instance in response to obtaining the second instance. The electronic device 301 may execute a function corresponding to the first layers 501 and the second layers 502 by executing the second instance. The electronic device 301 may perform inference for the input data by executing the second instance. According to an embodiment, the second instance may be used to verify inference data which is a result of the inference performed by executing the first instance. The verification will be described with reference to FIG. 7.

As a non-limiting example, the electronic device 301 may obtain or generate the second instance based on second composition information among the first composition information corresponding to the first layers 501 and the second composition information corresponding to the second layers 502. The electronic device 301 may execute the obtained second instance. For example, the electronic device 301 may execute a function corresponding to the second layers 502 by executing the second instance. The electronic device 301 may perform inference for the input data by executing the second instance. According to an embodiment, the electronic device 301 may perform verification on inference data, which is a result of the inference, using a third instance which will be described later.

According to an embodiment, the electronic device 301 may read the third layers 503 independently of the operation 520 and/or the operation 521. Since execution of the operation 520 and/or the operation 521 of the electronic device 301 and the operation of the electronic device 301 reading the third layers 503 are independent, the execution of the operation 520 and/or the operation 521 of the electronic device 301 and the operation of the electronic device 301 reading the third layers 503 may be performed simultaneously. The electronic device 301 may load composition information of each of the third layers 503 into the volatile memory 312 by sequentially reading each of the third layers 503. For example, the electronic device 301 may identify an end point included in composition information of a last layer (e.g., a layer N) in the third layers 503. For example, the electronic device 301 may execute an operation 530 in accordance with the end point.

According to an embodiment, in operation 530, the electronic device 301 may obtain or generate the third instance. The electronic device 301 may obtain or generate the third instance based on the first composition information (e.g., the first composition information 410) corresponding to the first layers 501, the second composition information (e.g., the second composition information 420) corresponding to the second layers 502, and the third composition information (e.g., the third composition information 430) corresponding to the third layers 503. The electronic device 301 may execute an operation 531 in response to obtaining the third instance.

In operation 531, the electronic device 301 may execute the third instance in response to obtaining the third instance. The electronic device 301 may execute a function corresponding to the first layers 501, the second layers 502, and the third layers by executing the third instance. For example, the electronic device 301 may execute a function corresponding to the model 320. The electronic device 301 may perform inference for the input data by executing the third instance. According to an embodiment, the third instance may be used to verify the inference data which is a result of the inference performed by executing the first instance. According to an embodiment, the third instance may be used to verify the inference data which is a result of the inference performed by executing the second instance. The verification will be described with reference to FIG. 7.

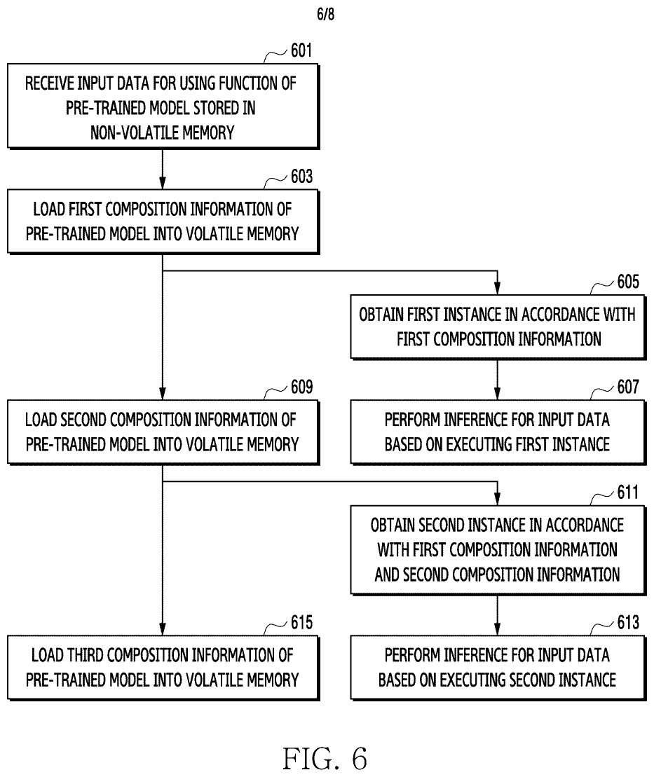

FIG. 6 illustrates an example of operations of an electronic device (e.g., the electronic device 301) that obtains an instance according to an embodiment of the disclosure.

Referring to FIG. 6, in operation 601, the electronic device 301 (e.g., the at least one processor 300) may receive input data for using a function of a pre-trained model (e.g., the model 320) stored in non-volatile memory (e.g., the non-volatile memory 311). For example, a function of the pre-trained model 320 may vary in accordance with learning.

In operation 603, the electronic device 301 (e.g., the at least one processor 300) may load (or copy) first composition information (e.g., the first composition information 410) of the pre-trained model 320 into volatile memory (e.g., the volatile memory 312). For example, the first composition information 410 may correspond to first layers (e.g., the first layers 401 and 501). For example, the first composition information 410 may include weight data of the first layers 401 and 501 and/or graph data of the first layers 401 and 501.

In operation 605, the electronic device 301 (e.g., the at least one processor 300) may obtain or generate a first instance in accordance with the first composition information 410. The electronic device 301 may execute a function in accordance with the first layers 401 and 501 by obtaining the first instance.

In operation 607, the electronic device 301 (e.g., the at least one processor 300) may perform inference for the input data based on executing the first instance. For example, the electronic device 301 may predict or process inference data for the input data by executing the first instance. For example, the electronic device 301 may obtain the inference data for the input data by executing the first instance. For example, in a case that a function of the first instance is translation, the electronic device 301 may obtain a translated text for an input text. For example, in a case that a function of the first instance is image classification, the electronic device 301 may obtain classification data for an input image.

In operation 609, the electronic device 301 (e.g., the at least one processor 300) may load (or copy) second composition information (e.g., the second composition information 420) of the pre-trained model 320 into the volatile memory (e.g., the volatile memory 312). For example, the second composition information 420 may correspond to second layers (e.g., the second layers 402 and 502). For example, the second composition information 420 may include weight data of the second layers 402 and 502 and/or graph data of the second layers 402 and 502.

According to an embodiment, the electronic device 301 may execute the operation 609 independently of the operation 605 and/or the operation 607. For example, while the operation 605 and/or the operation 607 are being executed, the electronic device 301 may execute the operation 609.

In operation 611, the electronic device 301 (e.g., the at least one processor 300) may obtain or generate a second instance in accordance with the first composition information 410 and the second composition information 420. The electronic device 301 may execute a function in accordance with the first layers 401 and 501, and the second layers 402 and 502 by obtaining the second instance.

According to an embodiment, the number of layers constituting the first instance may be less than the number of layers constituting the second instance. For example, the layers constituting the first instance may correspond to at least a portion of the layers constituting the second instance. For example, nodes of a first layer constituting the first instance may correspond to nodes of a second layer constituting the second instance. For example, a weight value assigned to the nodes of the first layer may correspond to a weight value assigned to the nodes of the second layer. For example, the weight value assigned to the nodes of the first layer may be the same as the weight value assigned to the nodes of the second layer. For example, the nodes of the first layer constituting the first instance and/or the weight value assigned to the corresponding nodes may be the same as the nodes of the second layer constituting the second instance and/or the weight value assigned to the corresponding nodes, and may be used redundantly.

In operation 613, the electronic device 301 (e.g., the at least one processor 300) may perform inference for the input data based on executing the second instance. For example, the electronic device 301 may predict or process inference data for the input data by executing the second instance. For example, the electronic device 301 may obtain the inference data for the input data by executing the second instance. For example, in a case that a function of the second instance is translation, the electronic device 301 may obtain a translated text for an input text. For example, in a case that a function of the second instance is image classification, the electronic device 301 may obtain classification data for an input image.

According to an embodiment, the second instance may be used to verify the inference data inferred by the first instance. For example, the electronic device 301 may determine whether second inference data outputted by the second instance corresponds to first inference data outputted by the first instance. The verification will be described and exemplified in FIG. 7.

According to an embodiment, the electronic device 301 may efficiently utilize usage of the volatile memory 312 and a capacity of the non-volatile memory 311 by using the first composition information 410 loaded into the volatile memory 312 to obtain the second instance.

In operation 615, the electronic device 301 (e.g., the at least one processor 300) may load (or copy) third composition information (e.g., the third composition information 430) of the pre-trained model 320 into the volatile memory (e.g., the volatile memory 312). For example, the third composition information 430 may correspond to third layers (e.g., the third layers 403 and 503). For example, the third composition information 430 may include weight data of the third layers 403 and 503 and/or graph data of the third layers 403 and 503.

According to an embodiment, the electronic device 301 may execute the operation 615 independently of the operation 611 and/or the operation 613. For example, while the operation 611 and/or the operation 613 are being executed, the electronic device 301 may execute the operation 615.

According to an embodiment, the electronic device 301 may obtain or generate a third instance in accordance with the first composition information 410, the second composition information 420, and the third composition information 430. The electronic device 301 may execute a function in accordance with the first layers 401 and 501, the second layers 402 and 502, and the third layers 403 and 503 by obtaining the third instance. For example, the electronic device 301 may execute a function in accordance with the model 320 by obtaining the third instance.

According to an embodiment, the third instance may be used to verify the inference data inferred by the first instance. The third instance may be used to verify the inference data inferred by the second instance. The verification will be described and exemplified in FIG. 7.

The number of instances (e.g., the first instance, the second instance, and the third instance) obtained by the electronic device 301 in FIG. 6 is an embodiment and is not limited thereto. For example, the number of instances generated from the model 320 may be determined in accordance with composition information of the model 320. As a non-limiting example, the number of instances generated from the model 320 may be determined in accordance with end point information.

FIG. 7 illustrates an example of a second instance 702 to verify inference data of a first instance 701 according to an embodiment of the disclosure. The first instance 701 may be an example of the first instance of FIG. 5 and/or FIG. 6. The second instance 702 may be an example of the second instance of FIG. 5 and/or FIG. 6. In FIG. 7, the first instance 701 and the second instance 702 are described as instances obtained based on an autoregressive model, but it is obvious that the embodiment is not limited thereto. The first instance 701 and the second instance 702 may include instances obtained based on various artificial intelligence models.

Referring to FIG. 7, the number of layers 710 of the first instance 701 may be less than the number of layers 720 of the second instance 702. For example, the layers 710 of the first instance 701 may correspond to at least a portion of the second layers 720 of the second instance 702. For example, the second layers 720 of the second instance 702 may include the layers 710 of the first instance 701.

According to an embodiment, the first instance 701 and the second instance 702 may be obtained based on a model (e.g., the model 320) stored in non-volatile memory (e.g., the non-volatile memory 311).

According to an embodiment, input data may include token 711 and/or token 712. For example, an electronic device (e.g., the electronic device 301) may perform inference for the token 711 and the token 712 by executing the first instance 701. For example, the electronic device 301 may output or obtain token 713 by the first instance 701. For example, the electronic device 301 may perform inference for the token 713 by executing the first instance 701. For example, the electronic device 301 may output or obtain token 714 by the first instance 701. For example, the first inference data may include the token 713 and/or the token 714.

According to an embodiment, the electronic device 301 may verify the first inference data obtained by the first instance 701 using the second instance 702. For example, the electronic device 301 may perform inference for the input data and the first inference data by executing the second instance 702. For example, the inference for the input data and the first inference data may be performed in parallel.

For example, the electronic device 301 may perform inference for the token 711 and the token 712. The electronic device 301 may output or obtain token 723. For example, the electronic device 301 may perform inference for the token 713. The electronic device 301 may output or obtain token 724. For example, the electronic device 301 may perform inference for the token 714. The electronic device 301 may output or obtain token 725.

The electronic device 301 may verify the token 713 by comparing the token 713 obtained by the first instance 701 and the token 723 obtained by the second instance 702. For example, the electronic device 301 may determine whether the token 713 obtained by the first instance 701 corresponds to the token 723 obtained by the second instance 702. For example, the electronic device 301 may remove the token 713 in accordance with a determination that the token 713 does not correspond to the token 723. The electronic device 301 may store the token 723 among the token 713 and the token 723 in accordance with the determination that the token 713 does not correspond to the token 723. For example, the electronic device 301 may determine to trust the token 713 in accordance with a determination that the token 713 corresponds to the token 723. For example, the electronic device 301 may compare the token 714 obtained by the first instance 701 and the token 724 obtained by the second instance 702 in accordance with the determination that the token 713 corresponds to the token 723.

According to an embodiment, the electronic device 301 may perform verification on the token 714 by comparing the token 714 obtained by the first instance 701 and the token 724 obtained by the second instance 702. For example, the electronic device 301 may determine whether the token 714 obtained by the first instance 701 corresponds to the token 724 obtained by the second instance 702. For example, the electronic device 301 may remove the token 714 in accordance with a determination that the token 714 does not correspond to the token 724. The electronic device 301 may store the token 724 among the token 714 and the token 724 in accordance with the determination that the token 714 does not correspond to the token 724. For example, the electronic device 301 may determine to trust the token 714 in accordance with a determination that the token 714 corresponds to the token 724. For example, the electronic device 301 may determine to trust the token 725 obtained by the second instance 702 in accordance with the determination that the token 714 corresponds to the token 724.

According to an embodiment, the electronic device 301 may perform verification on the first inference data obtained by the first instance 701 after executing the first instance 701 a preset number of times (e.g., twice).

According to an embodiment, since the number of layers 710 of the first instance 701 is less than the number of layers 720 of the second instance 702, the time for performing inference for the token using the first instance 701 may be less than the time for performing inference for the token using the second instance 702. For example, it may be assumed that the preset number of times is two, the time for performing inference for the token using the first instance 701 is 2 ms, and the time for performing inference for the token using the second instance 702 is 10 ms. For example, the time consumed by the electronic device 301 to obtain the token 713 and the token 714 by executing the first instance twice may be 4 ms. For example, when the electronic device 301 executes the second instance 702 once to verify the token 713 and the token 714, the time consumed may be 10 ms. In the verification, in a case that the token 723 corresponds to the token 713 and the token 724 corresponds to the token 714, 14 ms may be consumed to obtain the token 713 determined to be trusted by the electronic device 301, the token 714 determined to be trusted by the electronic device 301, and the token 725.

According to an embodiment, to obtain the token 723, the token 724, and the token 725 by executing only the second instance 702 among the first instance 701 and the second instance 702, the electronic device 301 may execute the second instance 702 three times. In order for the electronic device 301 to obtain the token 723, the token 724, and the token 725 by executing only the second instance 702, 30 ms may be consumed.

In an embodiment of the disclosure, quality of a case of performing inference for the input data by executing the first instance 701 and the second instance 702 may be higher than quality of a case of performing inference for the input data by executing only the second instance 702. For example, high quality may include less time consumed to obtain output data (e.g., a final result of inference).

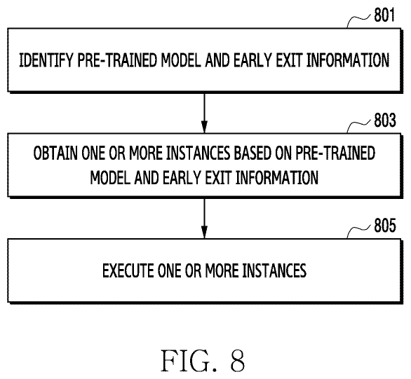

FIG. 8 illustrates an example of operations of an electronic device (e.g., the electronic device 301) that executes one or more instances according to an embodiment of the disclosure.

Referring to FIG. 8, in operation 801, the electronic device 301 (e.g., the at least one processor 300) may identify a pre-trained model (e.g., the model 320) and early exit information. The pre-trained model 320 may be stored in non-volatile memory (e.g., the non-volatile memory 311). For example, the early exit information may be stored in a file format in the non-volatile memory 311. However, it is not limited thereto. For example, the early exit information may be included in composition information of the pre-trained model 320.

In operation 803, the electronic device 301 (e.g., the at least one processor 300) may obtain one or more instances based on the pre-trained model 320 and the early exit information. The electronic device 301 may determine the number of the one or more instances in accordance with the pre-trained model 320 and the early exit information. The electronic device 301 may obtain or generate the one or more instances based on reading the pre-trained model 320. For example, the electronic device 301 may stop reading the pre-trained model 320 based on a determination that the number of obtained instances is the determined number of the one or more instances.

In operation 805, the electronic device 301 (e.g., the at least one processor 300) may execute the one or more instances. The electronic device 301 may execute each of the one or more instances in response to obtaining the corresponding instance. The electronic device 301 may perform inference for input data by executing the one or more instances.

In an embodiment according to the disclosure, the electronic device (e.g., the electronic device 301) may store the pre-trained model (e.g., the pre-trained model 320) in the non-volatile memory (e.g., the non-volatile memory 311). The electronic device 301 may obtain or generate the one or more instances based on loading the composition information of the model 320 into volatile memory (e.g., the volatile memory 312). For example, the electronic device 301 may efficiently utilize usage of the volatile memory 312 and a capacity of the non-volatile memory 311 by reusing at least a portion of the loaded composition information (e.g., the first composition information 410 and the second composition information 420) to obtain the one or more instances. In addition, the electronic device 301 may obtain inference data by executing a first instance (e.g., the first instance 701) among the one or more instances to perform inference for the input data. The electronic device 301 may execute a method of performing verification on the inference data using a second instance (e.g., the second instance 702) among the one or more instances. Quality of a case of performing inference for the input data by executing the first instance 701 and the second instance 702 may be higher than quality of a case of performing inference for the input data by executing only the second instance 702. For example, high quality may include less time consumed to obtain output data.

The effects that can be obtained from the disclosure are not limited to those described above, and any other effects not mentioned herein will be clearly understood by those having ordinary knowledge in the art to which the disclosure belongs, from the following description.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” or “connected with” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between a case in which data is semi-permanently stored in the storage medium and a case in which the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

The technical problems to be achieved in this disclosure are not limited to those described above, and other technical problems not mentioned herein will be clearly understood by those having ordinary knowledge in the art to which the disclosure belongs.

As described above, an electronic device (e.g., the electronic device 301) may include non-volatile memory including one or more storage media (e.g., the non-volatile memory 311) storing instructions. The electronic device may include volatile memory including one or more storage media, (e.g., the volatile memory 312). The electronic device may include at least one processor (e.g., the at least one processor 300) including processing circuitry, the at least one processor communicatively coupled to the non-volatile memory and the volatile memory. The instructions, when executed by the at least one processor individually or collectively, may cause the electronic device to receive input data for using a function of a pre-trained model (e.g., the model 320) stored in the non-volatile memory. The instructions, when executed by the at least one processor individually or collectively, may cause the electronic device to obtain, based on loading first composition information of the pre-trained model into the volatile memory, an instance in accordance with the loaded first composition information. The instructions, when executed by the at least one processor individually or collectively, may cause the electronic device to load second composition information of the pre-trained model, which is distinguished from the first composition information of the pre-trained model, into the volatile memory, independently of performing inference for the input data by executing the obtained instance.

According to an embodiment, the instructions, when executed by the at least one processor individually or collectively, may cause the electronic device to obtain, based on loading the second composition information into the volatile memory, a second instance distinguished from the first instance, in accordance with the first composition information and the second composition information. The instructions, when executed by the at least one processor individually or collectively, may cause the electronic device to perform inference for the input data based on executing the second instance.

According to an embodiment, the instructions, when executed by the at least one processor individually or collectively, may cause the electronic device to obtain first inference data for the input data based on executing the first instance. The instructions, when executed by the at least one processor individually or collectively, may cause the electronic device to obtain second inference data for the input data and the first inference data, based on executing the second instance. The instructions, when executed by the at least one processor individually or collectively, may cause the electronic device to perform verification on the first inference data, based on the first inference data and the second inference data.

According to an embodiment, the number of layers constituting the first instance may be less than the number of layers constituting the second instance.

According to an embodiment, the instructions, when executed by the at least one processor individually or collectively, may cause the electronic device to load the second composition information into the volatile memory while executing the instance.

According to an embodiment, the first composition information may include first weight data of first layers in the pre-trained model. The second composition information may include second weight data of second layers in the pre-trained model that follow the first layers in the pre-trained model.

According to an embodiment, the first composition information may include first graph data of first layers in the pre-trained model. The second composition information may include second graph data of second layers in the pre-trained model that follow the first layers in the pre-trained model.

According to an embodiment, the first composition information may include first weight data of first layers in the pre-trained model. The first graph data may comprise a structure and a computation of the pre-trained model.

According to an embodiment, the instructions, when executed by the at least one processor individually or collectively, may cause the electronic device to perform computations to obtain the instance based on the first graph data and on the first weight data.

As described above, a method performed by an electronic device (e.g., the electronic device 301) with non-volatile memory (e.g., the non-volatile memory 311) and volatile memory (e.g., the volatile memory 312) may include receiving, by the electronic device, input data for using a function of a pre-trained model (e.g., the model 320) stored in the non-volatile memory. The method may include obtaining, by the electronic device, based on loading first composition information of the pre-trained model into the volatile memory, an instance in accordance with the loaded first composition information. The method may include loading, by the electronic device, second composition information of the pre-trained model, which is distinguished from the first composition information of the pre-trained model, into the volatile memory, independently of performing inference for the input data by executing the obtained instance.

According to an embodiment, the method may include obtaining, based on loading the second composition information into the volatile memory, a second instance distinguished from the first instance in accordance with the first composition information and the second composition information. The method may include performing inference for the input data based on executing the second instance.

According to an embodiment, the method may include obtaining first inference data for the input data based on executing the first instance. The method may include obtaining second inference data for the input data and the first inference data, based on executing the second instance. The method may include performing verification on the first inference data, based on the first inference data and the second inference data.

According to an embodiment, the number of layers constituting the first instance may be less than the number of layers constituting the second instance.

According to an embodiment, the method may include loading the second composition information into the volatile memory while executing the instance.

According to an embodiment, the first composition information may include first weight data of first layers in the pre-trained model. The second composition information may include second weight data of second layers in the pre-trained model that follow the first layers in the pre-trained model.

According to an embodiment, the first composition information may include first weight data of first layers in the pre-trained model. The first graph data may comprise a structure and a computation of the pre-trained model.

According to an embodiment, the method may further include performing computations to obtain the instance based on the first graph data and on the first weight data.

According to an embodiment, the first composition information may include first graph data of first layers in the pre-trained model. The second composition information may include second graph data of second layers in the pre-trained model that follow the first layers in the pre-trained model.

As described above, in one or more non-transitory computer-readable storage media in which one or more computer programs are stored, the one or more programs may include computer-executable instructions that, when executed by at least one processor of an electronic device (e.g., the electronic device 301) including non-volatile memory (e.g., the non-volatile memory 311) and volatile memory individually or collectively (e.g., the volatile memory 312), cause the electronic device to perform operations, the operations including receiving, by the electronic device, input data for using a function of a pre-trained model (e.g., model 320) stored in the non-volatile memory, based on loading first composition information of the pre-trained model into the volatile memory, obtaining, by the electronic device, an instance in accordance with the loaded first composition information, and loading, by the electronic device, second composition information of the pre-trained model, which is distinguished from the first composition information of the pre-trained model, into the volatile memory, independently of performing inference for the input data by executing the obtained instance.

According to an embodiment, the operations may include obtaining, based on loading the second composition information into the volatile memory, a second instance distinguished from the first instance, in accordance with the first composition information and the second composition information, and performing inference for the input data based on executing the second instance.

According to an embodiment, the operations may include obtaining first inference data for the input data based on executing the first instance, obtaining second inference data for the input data and the first inference data, based on executing the second instance, and performing verification on the first inference data, based on the first inference data and the second inference data.

According to an embodiment, the number of layers constituting the first instance may be less than the number of layers constituting the second instance.

According to an embodiment, the operations may include loading the second composition information into the volatile memory while executing the instance.

According to an embodiment, the first composition information may include first weight data of first layers in the pre-trained model. The second composition information may include second weight data of second layers in the pre-trained model that follow the first layers in the pre-trained model.

According to an embodiment, the first composition information may include first graph data of first layers in the pre-trained model. The second composition information may include second graph data of second layers in the pre-trained model that follow the first layers in the pre-trained model.

According to an embodiment, the first composition information may include first weight data of first layers in the pre-trained model. The first graph data may comprise a structure and a computation of the pre-trained model.

According to an embodiment, the operations may further include performing computations to obtain the instance based on the first graph data and on the first weight data.

While the disclosure has been shown and described with reference to various embodiments thereof, it will be understood by those skilled in the art that various changes in form and details may be made therein without departing from the spirit and scope of the disclosure as defined by the appended claims and their equivalents.

No claim element is to be construed under the provisions of 35 U.S. C. § 112, sixth paragraph, unless the element is expressly recited using the phrase “means for“ or ”means”.

What is claimed is:

1. An electronic device comprising:
non-volatile memory comprising one or more storage media storing instructions;
volatile memory comprising one or more storage media; and
at least one processor comprising processing circuitry, the at least one processor communicatively coupled to the non-volatile memory and the volatile memory,
wherein the instructions, when executed by the at least one processor individually or collectively, cause the electronic device to:
receive input data for using a function of a pre-trained model stored in the non-volatile memory;
based on loading first composition information of the pre-trained model into the volatile memory, obtain an instance in accordance with the loaded first composition information; and
load second composition information of the pre-trained model, which is distinguished from the first composition information of the pre-trained model, into the volatile memory, independently of performing inference for the input data by executing the obtained instance.

2. The electronic device of claim 1,
wherein the instance is a first instance, and
wherein the instructions, when executed by the at least one processor individually or collectively, cause the electronic device to:
based on loading the second composition information into the volatile memory, obtain a second instance distinguished from the first instance, in accordance with the first composition information and the second composition information; and
based on executing the second instance, perform inference for the input data.

3. The electronic device of claim 2, wherein the instructions, when executed by the at least one processor individually or collectively, cause the electronic device to:
based on executing the first instance, obtain first inference data for the input data;
based on executing the second instance, obtain second inference data, for the input data and the first inference data; and
based on the first inference data and the second inference data, perform verification on the first inference data.

4. The electronic device of claim 2, wherein the number of layers constituting the first instance is less than the number of layers constituting the second instance.

5. The electronic device of claim 1, wherein the instructions, when executed by the at least one processor individually or collectively, cause the electronic device to:
while executing the instance, load the second composition information into the volatile memory.

6. The electronic device of claim 1,
wherein the first composition information includes first weight data of first layers in the pre-trained model, and
wherein the second composition information includes second weight data of second layers in the pre-trained model that follow the first layers in the pre-trained model.

7. The electronic device of claim 1,
wherein the first composition information includes first graph data of first layers in the pre-trained model, and
wherein the second composition information includes second graph data of second layers in the pre-trained model that follow the first layers in the pre-trained model.

8. A method performed by an electronic device with non-volatile memory and volatile memory, the method comprising:
receiving, by the electronic device, input data for using a function of a pre-trained model stored in the non-volatile memory;
based on loading first composition information of the pre-trained model into the volatile memory, obtaining, by the electronic device, an instance in accordance with the loaded first composition information; and
loading, by the electronic device, second composition information of the pre-trained model, which is distinguished from the first composition information of the pre-trained model, into the volatile memory, independently of performing inference for the input data by executing the obtained instance.

9. The method of claim 8,
wherein the instance is a first instance, and
wherein the method further comprises:
based on loading the second composition information into the volatile memory, obtaining a second instance distinguished from the first instance, in accordance with the first composition information and the second composition information; and
based on executing the second instance, performing inference for the input data.

10. The method of claim 9, further comprising:
based on executing the first instance, obtaining first inference data for the input data;
based on executing the second instance, obtaining second inference data, for the input data and the first inference data; and
based on the first inference data and the second inference data, performing verification on the first inference data.

11. The method of claim 9, wherein the number of layers constituting the first instance is less than the number of layers constituting the second instance.

12. The method of claim 8, comprising:
while executing the instance, loading the second composition information into the volatile memory.

13. The method of claim 8,
wherein the first composition information includes first weight data of first layers in the pre-trained model, and
wherein the second composition information includes second weight data of second layers in the pre-trained model that follow the first layers in the pre-trained model.

14. The method of claim 8,
wherein the first composition information includes first graph data of first layers in the pre-trained model, and
wherein the second composition information includes second graph data of second layers in the pre-trained model that follow the first layers in the pre-trained model.

15. One or more non-transitory computer-readable storage media storing one or more computer programs including computer-executable instructions that, when executed by at least one processor of an electronic device including non-volatile memory and volatile memory individually or collectively, cause the electronic device to perform operations, the operations comprising:
receiving, by the electronic device, input data for using a function of a pre-trained model stored in the non-volatile memory;
based on loading first composition information of the pre-trained model into the volatile memory, obtaining, by the electronic device, an instance in accordance with the loaded first composition information; and
loading, by the electronic device, second composition information of the pre-trained model, which is distinguished from the first composition information of the pre-trained model, into the volatile memory, independently of performing inference for the input data by executing the obtained instance.

16. The one or more non-transitory computer-readable storage media of claim 15,
wherein the instance is a first instance, and
wherein the operations further comprise:
based on loading the second composition information into the volatile memory, obtaining a second instance distinguished from the first instance, in accordance with the first composition information and the second composition information; and
based on executing the second instance, performing inference for the input data.

17. The one or more non-transitory computer readable storage media of claim 16, the operations further comprising:
based on executing the first instance, obtaining first inference data for the input data;
based on executing the second instance, obtaining second inference data, for the input data and the first inference data; and
based on the first inference data and the second inference data, performing verification on the first inference data.

18. The one or more non-transitory computer readable storage media of claim 16, wherein the number of layers constituting the first instance is less than the number of layers constituting the second instance.

19. The one or more non-transitory computer readable storage media of claim 15, the operations comprising:
while executing the instance, loading the second composition information into the volatile memory.

20. The one or more non-transitory computer readable storage media of claim 15,
wherein the first composition information includes first weight data of first layers in the pre-trained model, and
wherein the second composition information includes second weight data of second layers in the pre-trained model that follow the first layers in the pre-trained model.
